(19) United States
(12) Patent Application Publication
(10) Pub. No.: US 2006/0077210 A1
(43) Pub. Date: Apr. 13, 2006

(54) Rasterizing stacked graphics objects from top to bottom

(76) Inventors: John D. Morris, Walnut Creek, CA (US); Daniel J. Clark, Los Gatos, CA (US)

Correspondence Address: FISH & RICHARDSON P.C., P.O. Box 1022, MINNEAPOLIS, MN, 55440-1022, US

(21) Appl. No.: 10/964,798

(22) Filed: Oct. 13, 2004

(51) Int. Cl. G09G 5/00

(52) U.S. Cl. 345/613; 345/581

(57) ABSTRACT

Methods and apparatus, including computer program products, for rasterizing digital graphics objects having a stacking order. One method includes rasterizing the graphics objects by marking pixels in a pixel array, where each graphics object is separately rasterized according to a processing sequence that follows the stacking order from top to bottom; and, during the rasterization, tracking which pixels have been marked. Tracking which pixels have been marked can include using at least one tracking list that is associated with a scan line defining a sequence of pixels in a pixel array and that identifies marked or unmarked segments in the scan line. Rasterizing the graphics objects can include using the tracking list to identify markable pixels in the pixel array and marking only those pixels that are markable according to the tracking list. Marking pixels can include assigning any graphical attribute of a graphics object to the pixels.

### BACKGROUND

The present invention relates to processing digital images.

A digital image is digital data that defines a visual appearance. The digital image can define a visual representation for photographs, text, document pages, user interfaces or presentation objects, such as slide shows and animations. Digital images can be represented by vector graphic objects or raster graphic objects. Raster objects are defined by arrays of pixels that are basic picture elements. Each pixel represents a local portion of the image and alone or together with other pixels determines local attributes, such as color, gray level, luminosity, transparency or other graphical attribute of the image portion. A pixel array is typically represented by one or more bitmaps that assign a predefined number of bits to each pixel.

Vector graphic objects are used by object-oriented graphics to represent parts of the image. Each vector graphics object is a geometrical object, e.g., a line, a polygon, an arc or a circle, that is defined by one or more mathematical expressions. Each vector object can be associated with attributes, e.g., color, position, scaling, masking, line width and texture, that are used when the vector objects are rasterized on a pixel array. For example, the texture specifies variations of color, luminance or other graphical attribute within a surface portion that is defined by the vector object. Textures are often used to represent lighting or other three-dimensional effects. Digital images are represented by vector objects in a number of standard formats such as Portable Document Format (PDF) or PostScript, both developed by Adobe Systems Incorporated of San Jose, Calif.

An image can be defined by a digital stack of graphics objects, including vector or raster objects, over a background, which is typically a blank page. The stack defines a stacking order according to which the bottommost object is the closest to the background and each subsequent object lies above the previous objects in the stack. If the objects overlap at a particular location, the image's color can be defined at the particular location according to an opaque or a transparency rendering model.

In the opaque rendering model, a color is defined at any image location only by the color of the top object at that location. Thus, opaque rendering disregards any color that is specified by overlapping portions of underlying objects in the stack. Opaque rendering is traditionally realized by sequentially processing the objects in the stack from the bottom to the top, and rasterizing each object onto a pixel array by specifying the pixels' color or luminance values. Specifying pixel values is also referred to as “marking” or “writing” the pixels. In the transparency rendering model, potentially all overlapping objects can contribute to the final color according to some compositing rules. In the transparency model, the stack is typically also processed from bottom to top.

### SUMMARY

A system rasterizes graphics objects in a stack onto a pixel array according to a processing sequence that follows the stacking order from top to bottom. During the rasterization, the system tracks unmarked pixels. Thus the objects can be rasterized by marking only previously unmarked pixels in the array.

In general, in one aspect, the invention provides methods and apparatus, including systems and computer program products, for rasterizing graphics objects. A program product, for example, has instructions that can be executed to cause data processing apparatus to perform the operations of receiving graphics objects having a stacking order defined by a stack; rasterizing the graphics objects by marking pixels in a pixel array, wherein each graphics object is separately rasterized according to a processing sequence that follows the stacking order from top to bottom; and, during the rasterization, tracking which pixels have been marked in the pixel array.

Advantageous implementations can include one or more of the following features. Receiving graphics objects includes receiving two or more opaque graphics objects, which can overlap. Receiving graphics objects includes receiving a list of graphics objects, the list defining upward links between adjacent graphics objects in the stack according to a sequence that follows the stacking order from bottom to top. The operations further include specifying downward links for the list, the downward links connecting adjacent graphics objects in the stack according to a sequence that follows the stacking order from top to bottom.

The following features can also be included. Tracking which pixels have been marked includes using at least one tracking list that is associated with a scan line defining a sequence of pixels in the pixel array and that identifies marked or unmarked segments in the scan line. Each marked or unmarked segment is specified by one or more scan line coordinates identifying one or more of a beginning, an end, or a length of the segment in the scan line. Tracking which pixels have been marked in the pixel array includes updating the tracking list.

The following features can also be included. Rasterizing the graphics objects includes using the tracking list to identify markable pixels in the pixel array; and marking only those pixels that are markable according to the tracking list. The tracking list identifies unmarked pixels and only those pixels are marked that are identified as unmarked by the tracking list. Using the tracking list to determine markable pixels includes specifying a mask that identifies pixels to be marked. Updating the tracking list includes updating a tracking bitmap that assigns a tracking value to each pixel in the pixel array, or updating a tracking list that identifies marked or unmarked segments of a scan line defining a sequence of pixels in the pixel array. The scan line includes a row or a column of pixels in the pixel array. Marking pixels in the pixel array includes assigning graphical attributes of a graphics object to the pixels in the pixel array.

The following features can also be included. Tracking which pixels have been marked in the pixel array includes tracking which pixels have been fully marked and tracking which pixels have been partially marked, each partially marked pixel having multiple subpixels. The operations further include tracking which subpixels of each partially marked pixel have been marked without attributing any graphical attribute to any marked subpixel as such. Marking a partially marked pixel in the pixel array includes interpolating a graphical attribute of a graphics object and a corresponding graphical attribute of the partially marked pixel to generate a final graphical attribute for the pixel as a whole, and updating which subpixels of the pixel have been marked.

The invention can be implemented to realize one or more of the following advantages. Overlapping opaque objects can be rasterized onto a pixel array without repeatedly marking the same pixels. Thus each pixel is marked no more than once, and a large number of overlapping opaque objects can be efficiently rasterized onto the pixel array. A large amount of processing time can be saved by avoiding that the same pixels be marked over and over again during the rasterization. Compared to traditional rasterization, the processing time can be reduced by a large factor, such as ten or even a few hundred, depending on the number of overlapping objects. By processing the stack from top to bottom, throughput can be substantially improved in high resolution printing systems, such as PostScript printing systems. Thus, less processing power may be required for the printing, and more complex documents can be printed with traditional printers. The top-to-bottom processing techniques can also be implemented to rasterize stacked windows or other objects on a display monitor. The drawing surface does not have to be initialized to a known state before drawing begins. Instead, the particular background can be marked only on previously unmarked pixels after all objects in the stack has been processed. The unmarked pixels can be tracked in a compact and efficient way using a respective tracking list of unmarked segments for each scan line in the pixel array. The number of tracking lists is proportional only to the number of scan lines, and each tracking list may identify only a finite number of unmarked segments. Thus, compared to a tracking bitmap that explicitly assigns a tracking value to each pixel in the array, the tracking lists use substantially fewer resources and require less computation for the tracking.

The details of one or more implementations of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 is a schematic diagram illustrating a rasterizer for processing a stack of graphics objects.

FIG. 2 is a flowchart illustrating a method for rasterizing stacked graphics objects.

FIG. 3 is a schematic diagram illustrating an exemplary stack of overlapping objects and comparing bottom-to-top and top-to-bottom rasterizations of the stacked objects.

FIG. 4 is a flowchart illustrating a method for tracking unmarked segments in a scan line.

FIG. 5 is a schematic diagram illustrating an exemplary implementation for tracking unmarked segments in a scan line.

FIG. 6 is a flowchart illustrating tracking unmarked subpixels in a process of anti aliasing.

Like reference numbers and designations in the various drawings indicate like elements.

### DETAILED DESCRIPTION

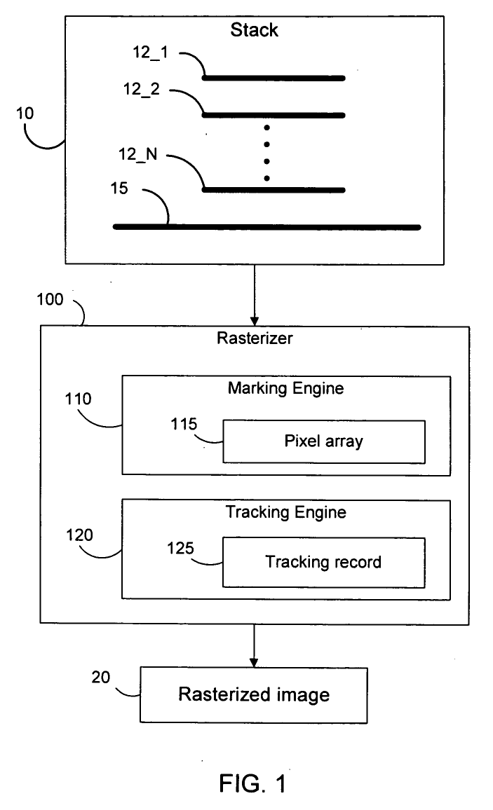

FIG. 1 illustrates a rasterizer 100 that receives a digital stack 10 of graphics objects and rasterizes the graphics objects onto a pixel array 115 to generate a rasterized image 20. The rasterizer 100 separately rasterizes each graphics objects in the stack 10 according to a processing sequence that follows the stacking order from top to bottom. The rasterizer 100 tracks unmarked pixels in the array to avoid repeatedly marking the same pixels during the rasterization.

The rasterizer 100 can be implemented in one or more software applications or as a plug-in to a software application. The rasterizer 100 can also be implemented in electronic devices, such as printing or image displaying devices. The image displaying devices can include portable devices, such as personal digital assistants or mobile phones. For portable devices, the rasterizer 100 or portions of it can be implemented on a remote server.

The rasterizer 100 receives the stack 10 that includes multiple (“N”) graphics objects 12_1, 12_2, . . . , 12_N arranged over a background 15 to define an image or a portion of the image. The graphics objects 12_1, . . . , 12_N can include any graphics objects, such as vector objects, bitmaps or character fonts. The background 15 can be a blank document page or a screen. Alternatively, the background can specify a background pattern, such as a background image. The graphics objects 12_1, . . . , 12_N are arranged in the stack 10 over the background 15 according to a stacking order that specifies the graphics object 12_1 as the topmost object in the stack 10, and the graphics object 12_N as the bottommost object that is closest to the background 15.

In PostScript format, the stack 10 can be defined by a PostScript data stream for which the stacking order is specified by the order in which the objects appear in the data stream. Or the stack 10 can be defined by an intermediate structure such as a display list that specifies the objects to be rendered and attributes for rendering the objects. The rendering attributes can include geometric shape, texture, color, and a clipping path.

In one implementation, the received stack 10 is defined by a list that links subsequent objects in the stack according to a bottom-to-top sequence. The bottom-to-top linking corresponds to the traditional bottom-to-top processing of the stack. To facilitate top-to-bottom processing of the stack 10, the rasterizer 100 can modify the received stack 10 by specifying additional links that connect adjacent objects of the stack in the reverse direction, from the top to the bottom of the stack 10. With the additional links, the stack 10 can be traversed either in a bottom-to-top or a top-to-bottom direction.

Each of the graphics objects 12_1, . . . , 12_N is an opaque object that obscures overlapping portions of underlying objects in the stack 10. In alternative implementations, one or more of the graphics objects 12_1, . . . , 12_N can be transparent. The transparent objects can be preprocessed to generate a representation that includes only opaque objects. In one implementation, the preprocessing identifies regions in which transparent objects overlap with other objects, and for each overlapping region, a new object is defined by compositing the colors of all the overlapping objects in the corresponding region. Once all transparent compositing has been performed, the composite objects can be further processed as opaque objects.

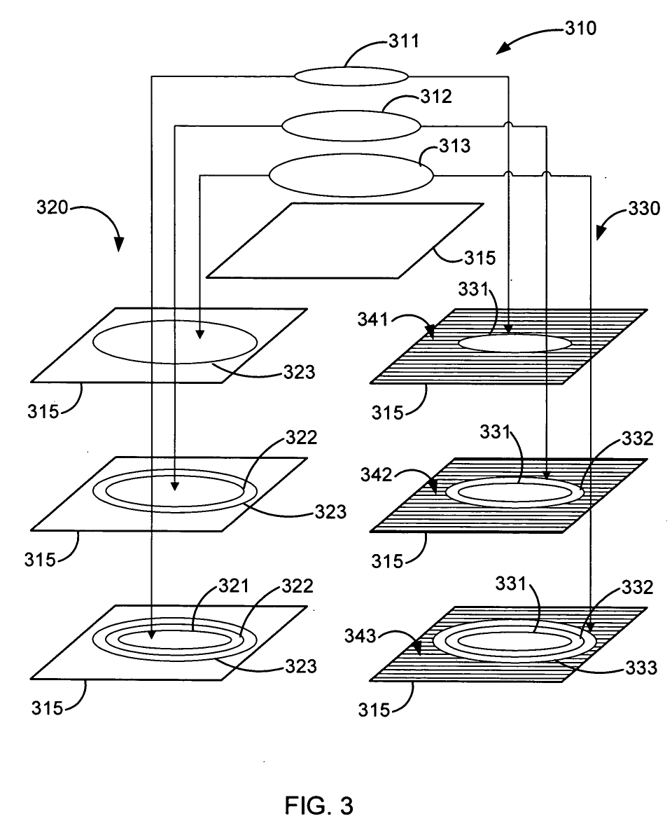

The rasterizer 100 includes a marking engine 110 and a tracking engine 120. The marking engine 110 rasterizes the graphics objects 12_1, . . . , 12_N onto the pixel array 115, and during the rasterization, the tracking engine 120 generates and updates a tracking record 125 to identify which pixels can be marked in the pixel array. In one implementation, the marking engine 110 marks only those pixels that the tracking record 125 identifies as unmarked pixels. Thus when the tracking record 125 is updated such that all previously marked pixels are excluded from the unmarked pixels, the rasterizer 100 can avoid overwriting the same pixels when overlapping opaque objects are rasterized. An exemplary implementation for rasterizing overlapping objects is discussed with reference to FIG. 3.

In alternative implementations, the rasterizer 100 can overwrite some of the previously marked pixels. For example, a bottom portion of the stack can be processed traditionally, from bottom to top, to define a new background for the rest, top portion of the stack, which can be rasterized onto the new background from top to bottom. Or pixels can be overwritten to achieve transparency effects if the stack 10 includes a transparent object. For example, when the transparent object overlaps with and lies immediately above an opaque object, and the stack 10 is processed from top to bottom, the transparent object is rasterized first onto a pixel array. Thus when the underlying opaque object is rasterized, previously marked transparent pixels may be rewritten according to some compositing rules.

The pixel array 115 includes multiple pixels that are arranged in an array that has a rectangular or some other shape. The pixel array 115 can represent a display screen, a window in a user interface, or a document page to be printed. Printing applications typically require high resolution pixel arrays. Thus, repeatedly marking the same pixels in the high resolution array 115 may require a large amount of processing that can be substantially reduced when each pixel is marked no more than once.

The marking engine 110 rasterizes the graphics objects 12_1, . . . , 12_N by marking pixels in the pixel array 115. A pixel is marked if the marking engine 110 has assigned a color or other attribute of a graphics object to the pixel. The marking engine 110 rasterizes the graphics object 12_1, . . . , 12_N separately, one at a time, according to a processing sequence that follows the stacking order from the top to the bottom of the stack 10. During or after the rasterization of each graphics object, the tracking record 125 is updated based on which pixels have been marked to rasterize the object.

The tracking engine 120 generates and updates the tracking record 125, which identifies the unmarked pixels in the pixel array 115. Instead of or in addition to unmarked pixels, the tracking record 125 can also identify pixels that have been marked in the pixel array 115. When rasterizing a transparent object, the tracking record 125 can also identify transparent pixels to indicate that these pixels can be rewritten when underlying objects are rasterized.

The tracking record 125 can be implemented by a tracking bitmap that assigns a binary value to each pixel in the array 115. The binary value, such as zero or one, specifies whether the pixel is unmarked or marked. The tracking bitmap includes as many elements as the number of pixels in the pixel array. Thus for an array of N times M pixels, the tracking bitmap also has N times M elements.

The tracking record 125 can also be implemented by one or more tracking lists that identify uninterrupted sequences of unmarked pixels (alternatively, uninterrupted sequences of marked pixels) in the pixel array 115. For example, a respective tracking list can be defined for each scan line in the pixel array 115, where each tracking list identifies segments that include only unmarked (alternatively, marked) pixels in the respective scan line. The tracking list can identify the segments by their starting and ending locations in the scan line or by their location and length in the scan line.

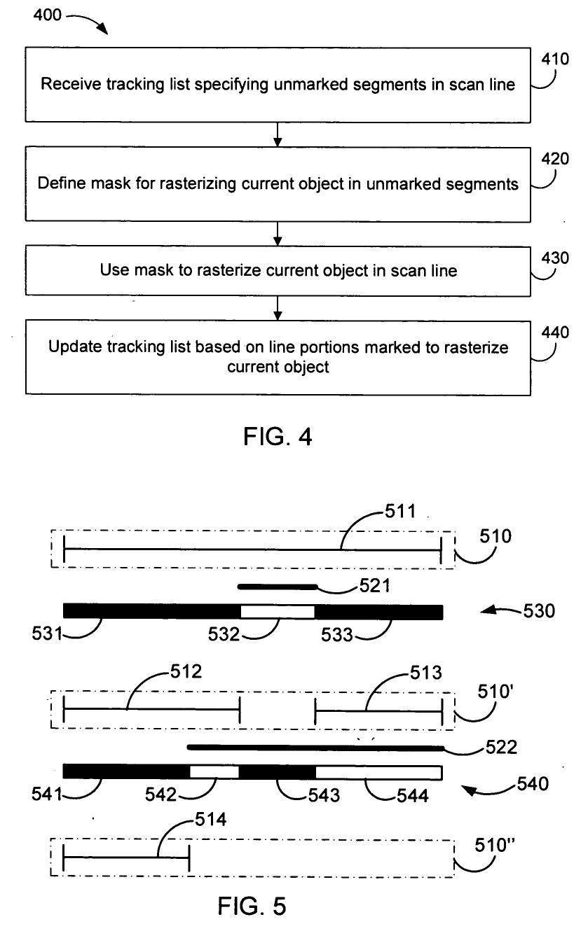

For an array including N scan lines and any number of pixels in each scan line, the system can define N tracking lists. For many images, the number of unmarked or marked segments remains limited in most scan lines during rasterization. Thus the tracking lists will have a total number of elements that is still proportional only to N, the number of tracking lists. Using tracking lists to identify unmarked or marked pixels is further discussed with reference to FIGS. 4 and 5.

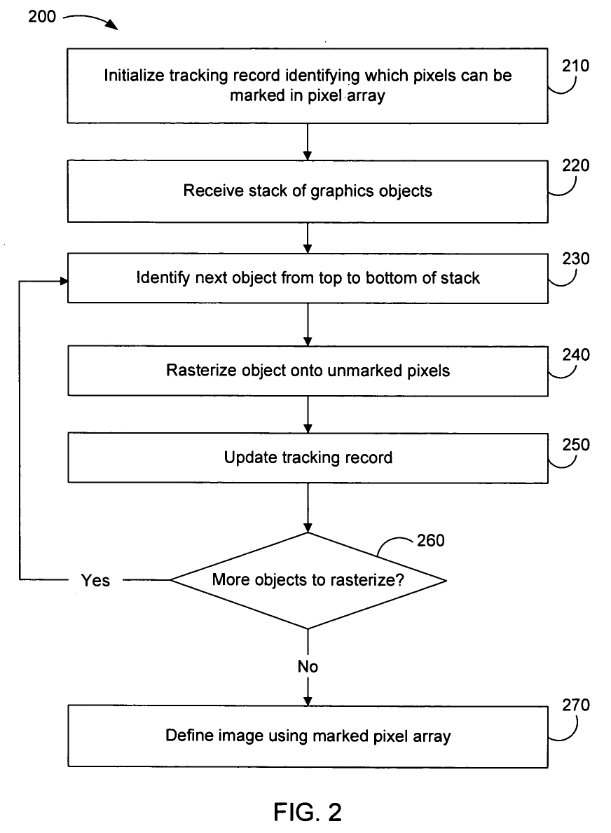

FIG. 2 illustrates a method 200 for rasterizing stacked objects that define a digital image or a portion of a digital image. The method 200 can be performed by a system that includes the rasterizer 100.

The system initializes a tracking record (step 210). The tracking record identifies which pixels can be marked in a pixel array onto which the system rasterizes graphics objects. For example, the tracking record can identify unmarked pixels. Or the tracking record can identify previously marked pixels that cannot be marked again in later rasterization. The system can initialize the tracking record by specifying all pixels in the pixel array as being unmarked. Alternatively, the tracking record can be initialized by specifying only a portion of the pixel array as being unmarked, where the unmarked portion corresponds to a “markable” portion of the pixel array. The remaining, “non-markable” portion can be excluded from the rasterization, for example, by treating the non-markable portion as if it has been already marked. The markable portion can correspond to a window in which the image is rasterized on a display screen or a document page.

The tracking record can include a tracking bitmap or one or more tracking lists. The tracking bitmap is initialized by assigning an “unmarked” value to all markable pixels in the array. Non-markable pixels can be initialized by assigning a “marked” value to them. The tracking lists include a respective tracking list for each scan line. If a tracking list identifies unmarked segments, it can be the initialized by specifying a single unmarked segment that includes the entire scan line. Or the initialization can specify unmarked segments that include only one or more markable portions of the line. If the tracking list identifies marked segments, the initialization can specify no marked segments at all. To exclude one or more non-markable portions of the line, the non-markable portions can be specified as marked segments.

The system receives a stack of graphics objects (step 220). The stack includes two or more opaque graphics objects, and defines a stacking order that is a sequence in which the graphics objects are overlaid on a background. When rasterized, each opaque graphics object obscures overlapping portions of underlying objects in the stack. The stack can be defined by links that connect adjacent graphics objects in the stack. The links can be unidirectional or bidirectional links. Unidirectional links define the stacking order only in one direction, either bottom to top or top to bottom. Bidirectional links define the stacking order in both directions, bottom to top as well as top to bottom. If the received stack has only unidirectional links, the system can add new links that specify the stacking order in the reverse direction.

The system identifies a next object in the stack in the direction of top to bottom (step 230). In the first iteration, the system identifies the topmost object in the stack. In each subsequent iteration, the system identifies the object immediately underneath the previously selected object in the stack. When the stack is linked in the top-to-bottom direction, the system can identify the next object in the stack using the top-to-bottom link from the previously selected object. If the stack has only bottom-to-top links, the system can first identify the bottommost object and use the bottom-to-top links of the underlying objects until the desired next object is found.

The system rasterizes the identified graphics object onto pixels that are unmarked in the pixel array according to the tracking record (step 240). In one implementation, the system generates a mask that defines “markable” and “non-markable” regions. The mask's markable regions include unmarked array portions that overlap with the object, and the non-markable regions include the previously marked regions. The system uses the generated mask to identify which pixels can be marked when the graphics object is rasterized. Using masks is further discussed with reference to FIGS. 4 and 5.

Alternatively, the system can separately verify for each pixel that is covered by a currently rasterized object, whether that pixel has been already marked or not according to the corresponding tracking record. For example, the tracking record can include a tracking bitmap and the system can verify the pixel's marking status in the corresponding element of the bitmap. Verifying each pixel's marking status, however, may require substantially more processing than generating a mask and processing only the pixels that can be marked according to the mask.

The system updates the tracking record (step 250). The update is based on which pixels have been marked to rasterize the graphics object. The tracking record can be updated by removing the recently marked portions of the pixel array from the unmarked regions specified by the tracking record before rasterizing the object. Or the recently marked portions of the pixel array can be added to the marked regions specified by the tracking record before rasterizing the object. If the top object is rasterized using a mask and the rasterization marked all markable pixels specified by the mask, the mask can be used to update the tracking record. If the tracking record includes a tracking bitmap, a respective tracking value can be updated in the bitmap each time a pixel is marked in the pixel array.

The system determines whether the stack includes graphics objects that have not been rasterized (decision 260). If the stack includes non-rasterized objects (“Yes” branch of decision 260), the system identifies the next object in the stack in the direction of top to bottom (returns to step 230), rasterizes that object (step 240), and updates the tracking record (step 250). If all objects have been rasterized (“No” branch of decision 260), the system defines a digital image using the marked pixel array (step 270). The defined image can be displayed or printed based on the marked pixel array.

FIG. 3 illustrates a stack 310 of exemplary opaque graphics objects 311, 312 and 313 that are rasterized according to a bottom-to-top rasterization process 320 and a top-to-bottom rasterization process 330. The stack 310 is defined over a background that is represented by a pixel array 315. In the stack 310, the graphics object 311 is the topmost object, the graphics object 313 is the bottommost object, and the object 312 is a middle object in between the topmost and bottommost objects 311 and 313. The objects 311, 312 and 313 represent concentric circles whose radius is increasing with their position starting with the smallest radius from the top of the stack 310. Thus the topmost object 311 defines the smallest radius, and the middle and bottommost objects 312 and 313 represent circles with progressively larger radii.

The process 320 rasterizes the objects in the stack 310 in the traditional order, from the bottom to the top. Thus the bottommost object 313 is the first to be rasterized by marking pixels of the pixel array 315 within a region 323 that corresponds to the circle with the largest radius. Next, the middle object 312 is rasterized by marking pixels of the pixel array 315 within a region 322 that corresponds to the concentric circle with the middle radius. Thus the region 322 overlaps with the region 323. Within the region 322, the pixels are first marked when the bottommost object 313 is rasterized, and the same pixels are rewritten when the middle object 312 is rasterized. Next, the topmost object 311 is rasterized by marking pixels within a region 321 that represents the smallest circle and overlaps with the region 321 of the pixel array 315. Within the region 321, the pixels are marked the first time when the bottommost object 313 is rasterized, the second time when the middle object 312 is rasterized, and the third time when the topmost object 311 is rasterized. Thus in the traditional process 320, a large number of pixels may be rewritten one or more times when overlapping objects are rasterized.

The process 330 rasterizes the objects in the stack 310 in a reverse order, from the top to the bottom, and tracks which pixels have been marked. In the reverse order, the topmost object 311 is the first to be rasterized by marking pixels within a region 331 in the pixel array 315 to represents the smallest circle. After rasterizing the topmost object 311, the rasterizing process 330 identifies an unmarked portion 341 of the pixel array 315. The unmarked portion 341 specifies markable pixels that can be marked when a subsequent object is rasterized onto the pixel array 315.

Next, the middle object 312 is rasterized by marking only previously unmarked pixels in the pixel array 315. Because the unmarked pixels are only within the portion 341, the middle object 312 is rasterized by marking pixels within a region 332 that is defined by the region where the middle object 312 overlaps with the unmarked portion 341. Thus although the middle object 312 specifies a full circle, the marked region 332 has a ring shape surrounding the smallest circle represented by the region 331. After rasterizing the middle object 312, the unmarked pixels are updated and defined by a region 342.

The bottommost object 313 is rasterized last in the stack 310, and only previously unmarked pixels are marked in a ring-shaped region 333 of the pixel array 315. The currently marked region 333 is defined by the region where the bottommost object 313 overlaps with the unmarked region 342. Thus all objects 311-313 in the stack 310 have been rasterized without overwriting previously marked pixels.

After processing the entire stack 310, both of the processes 320 and 330 define the same marked pixel array. The traditional process 320 has marked the same pixels over and over again in the regions where the graphics objects overlap. The reverse process 330, on the other hand, marked pixels only once. If the pixel array includes a large number of pixels or a large number of overlapping objects should be rasterized, the reverse process 330 can substantially accelerate the rasterization by avoiding the overwriting of previously marked pixels.

FIG. 4 illustrates a method 400 for rasterizing a current graphics object onto a scan line that is a sequence of pixels, such as a row or a column of pixels in a rectangular pixel array. For multiple scan lines, the method 400 can be performed separately for each line. The current graphics object is in a stack of objects that is processed from the top to the bottom, as discussed above with reference to FIG. 2. The current graphics object is rasterized in the scan line by marking pixels that have not been previously marked. The method 400 also updates a tracking list that identifies unmarked pixels in the line. The updated tracking list can be used to rasterize a next object in the stack. In one implementation, the method 400 is performed by a system that includes the rasterizer 100 (FIG. 1).

The system receives a tracking list that specifies one or more unmarked segments in the scan line (step 410). Each unmarked segment identifies a line portion that includes only unmarked pixels, and separate unmarked segments define disjoint portions of the line. If the received unmarked segments overlap, the system can define disjoint segments by uniting the overlapping segments. In the tracking list, the disjoint segments can be organized into a sequence along the scan line. Each unmarked segment can be specified by one or more scan line coordinates identifying the either or both ends or one end and the length of the segment.

The system defines a mask for rasterizing the current object in the unmarked segments (step 420). The mask specifies one or more marking windows within which pixels can be marked when the current object is rasterized on the scan line. In one implementation, each unmarked segment of the tracking list defines a respective marking window in the mask. This implementation allows marking any of the previously unmarked pixels when the current object is rasterized.

Alternatively, the mask can be defined based on both the tracking list and the current object. The current object specifies graphical attributes, such as colors, in one or more portions of the scan line, and the marking windows of the mask are defined only by those portions of the unmarked segments for which graphical attributes are specified by the current object. Thus, the mask allows marking only those pixels that indeed will be marked when the object is rasterized, and if there is no overlap between the unmarked segments and the current object, the mask specifies no marking window at all. Such masks can be defined by scanning and comparing the unmarked segments and the line portions to be marked by the current object.

The system uses the mask to rasterize the current object (step 430), and updates the tracking list based on line portions that have been marked to rasterize the current object (step 440). To rasterize the current object, the system uses the marking windows of the mask to identify which pixels can be marked with the graphical attributes of the current object. The tracking list is updated by modifying the specified unmarked segments in the list such that all pixels that have been marked will be removed from the list. For example, the system can record which pixels have been marked during the rasterization of the current object, and modify the unmarked segments accordingly. If the mask is specified based on the overlap regions of the current object and the initial unmarked segments, the mask can also be used to modify the unmarked segments.

FIG. 5 illustrates an exemplary implementation of tracking unmarked segments in a scan line when a system rasterizes a first and second graphics objects 521 and 522 onto the scan line. The first graphics object 521 is immediately above the second graphics object 522 in a stack that is processed from top to bottom. Accordingly, the first object 521 is rasterized before the second object 522. A tracking list 510 identifies a single unmarked segment 511 of the scan line before the rasterization.

To rasterize the first graphics object 521, a first mask 530 is defined based on the first object 521 and the unmarked segment 511 in the tracking list 510. The first mask 530 specifies a marking window 532 that is defined by the overlapping region of the first object 521 and the unmarked segment 511. Along the scan line, the marking window 532 is preceded and followed by non-markable segments 531 and 533, respectively. The first object 521 is rasterized by marking pixels within the marking window 532.

The tracking list 510 is updated based on the first mask 530. The updated tracking list 510′ specifies two unmarked segments 512 and 513 that are generated by removing a portion from the unmarked segment 511. The removed portion is defined by the marking window 532 of the first mask 530, because the pixels in the marking window 532 has been marked when the first object 521 has been rasterized.

To rasterize the second graphics object 522, a second mask 540 is defined based on the second object 522 and the unmarked segments 512 and 513 in the updated tracking list 510′. The second mask 540 specifies two marking windows 542 and 544 that are defined by the overlapping regions of the second object 522 and the unmarked segments 512 and 513. Along the scan line, the marking window 542 is preceded by a non-markable segment 541 and followed by another non-markable segment 543 that separates the marking windows 542 and 544 from each other. The second graphics object 522 is rasterized by marking pixels within the marking windows 542 and 544.

Next, the tracking list 510′ is updated based on the second mask 540. The updated tracking list 510″ specifies a single unmarked segment 514 that is generated by removing a portion from the unmarked segment 512 of the tracking list 510′. The removed portion is defined by the marking window 542 of the second mask 540. The unmarked segment 513 has been entirely removed from the tracking list 510′, because it is entirely covered by the marking window 544. Thus after the pixels has been marked in both of the marking windows 542 and 544, and the corresponding regions have been removed from the tracking list, the updated tracking list 510″ correctly identifies all unmarked pixels after the rasterization of the second object 522. The updated tracking list 510″ can be used to rasterize a next object beneath the second object 522 in the stack.

Processing objects in a top-to-bottom order can also be used to implement high quality antialiasing of graphic objects.

The known antialiasing technique of generating alpha and blending is very fast but creates antialias seams for objects that are painted next to each other. A known alternative technique is to render the entire artwork at a higher resolution (e.g., 4×) and to average the resulting subpixels (e.g., 4×4 subpixels) into antialiased artwork. This technique avoids the creation of alpha antialiasing seams; but it paints, in the case of a 4× rendering, 16 times the number of pixels, and still needs to average the image down after rendering it.

The top-to-bottom antialiasing technique that will now be described has the advantage that it provides the same quality as the high-resolution rendering and downsampling technique described above, without requiring that all subpixels be separately marked. In the example of a 4× rendering and marking with color, the technique keeps a subpixel marking record of 16 bits per pixel to keep track of which of the 16 subpixels are already marked. Subpixel marking needs to be tracked only for partially marked pixels. Processing objects from top to bottom, once a subpixel is marked, it stays marked, which means that the process never needs to remove color from a subpixel that has already been marked. The process therefore can avoid storing actual color values for the subpixels and thereby achieves a substantial savings in memory usage in comparison to methods that fully render the image at a higher resolution. As each new object is marked, the subpixel marking record is checked to determine which subpixels were already marked. If the new object marks only marked subpixels, the pixel is not marked further. If any new subpixels are to be marked, the process knows how many will be marked, and the final pixel color is calculated by interpolating the new pixel color (i.e., the color from the new object) and the old pixel color using the ratio of the counts of newly marked subpixels to previously marked subpixels. After all objects in the stack have been processed, if any subpixels remain unmarked, they are marked with a final color—e.g., a white color or a background color—to ensure that all unmarked subpixels are properly blended.

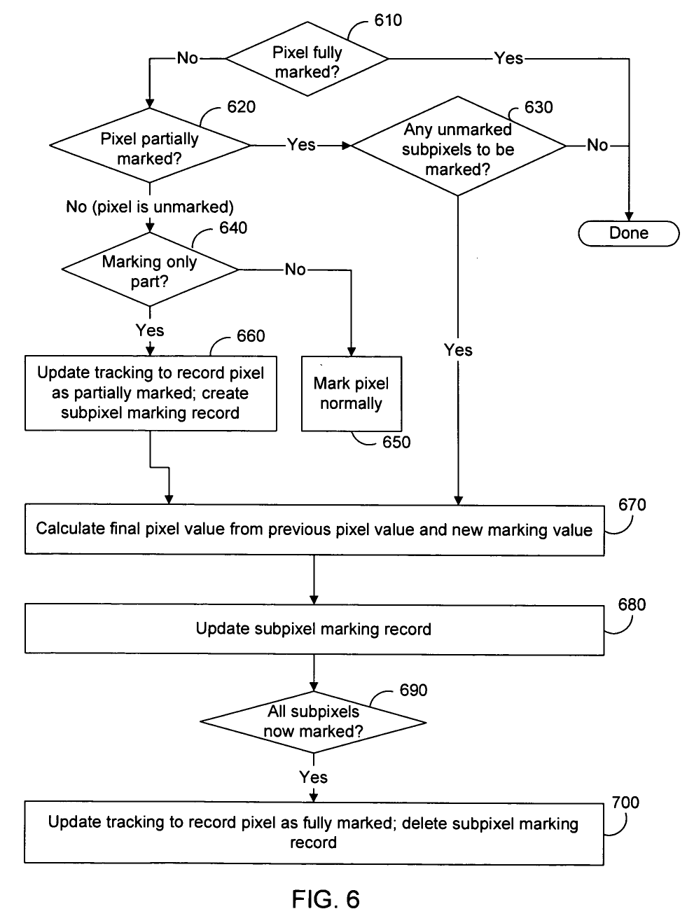

As indicated in FIG. 6, when object processing includes antialiasing, the tracking record can identify, or record the status of, pixels as being partially marked in addition to identifying pixels as being marked (in this context, fully marked) or unmarked. For each partially marked pixel, the process tracks which of its subpixels have been marked. This will be described as being done using a subpixel marking record, which can be any data structure that can store the required information. For a 4×4 subpixel arrangement, a 16-bit word can be used to store subpixel status.

If a pixel to be marked by a new object—i.e., by an object from the stack now being processed—is already fully marked (“yes” branch from step 610), then no further marking is done, as described earlier. Similarly, if the pixel is partially marked (“yes” branch from step 610) and the object will not mark any unmarked subpixels in the pixel (“no” branch from step 630), then no further marking is done, as described earlier.

If, however, the pixel is neither fully nor partially marked (“no” branch from step 620), the pixel is necessarily unmarked. In this case, if the entire pixel is being marked by the new object (“no” branch from step 640), it pixel is marked normally (650), that is, as described earlier. On the other hand, if the unmarked pixel will be marked only in part (“yes” branch from step 640), the process updates the tracking record to identify the pixel as partially marked and creates or allocates a subpixel marking record for the pixel and initializes it (660).

In this case, and in the case that the new object will mark previously unmarked subpixels in the pixel (“yes” branch from step 630), a final pixel value is calculated (670). For the sake of exposition, and because antialiasing is generally relates to color, the pixel value has been described as a color; however, the value can also be a gray level, luminosity, texture, transparency or other graphical attribute. The final value can be calculated as a linear interpolation of the old (previous) value of the pixel attribute (e.g., the color) and the new value from the new object, for example, as follows:
final_value=((old_value x count_of_previously_marked_subpixels)+(new_value x count_of_newly_marked subpixels))/(count_of_previously_marked_subpixels+count_of_newly_marked subpixels)

The subpixel marking record is also updated (680). If all subpixels of the pixel are now marked (“yes” branch from step 690), the tracking record is updated to identify the pixel as fully marked and the subpixel marking record is deleted or deallocated (700).

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

By way of example, a printing device implementing an interpreter for a page description language, such as the PostScript® language, includes a microprocessor for executing program instructions (including font instructions) stored on a printer random access memory (RAM) and a printer read-only memory (ROM) and controlling a printer marking engine. The RAM is optionally supplemented by a mass storage device such as a hard disk. The essential elements of a computer are a processor for executing instructions and a memory. A computer can generally also receive programs and data from a storage medium such as an internal disk or a removable disk. These elements will also be found in a conventional desktop or workstation computer as well as other computers suitable for executing computer programs implementing the methods described here, which can be used in conjunction with any digital print engine or marking engine, display monitor, or other raster output device capable of producing color or gray scale pixels on paper, film, display screen, or other output medium.

The invention has been described in terms of particular embodiments. Other embodiments are within the scope of the following claims. For example, the steps of the invention can be performed in a different order and still achieve desirable results.

What is claimed is:

1. A computer program product, tangibly embodied in an information carrier, for rasterizing graphics objects, the product comprising instructions operable to cause data processing apparatus to perform operations comprising:
receiving graphics objects having a stacking order defined by a stack;
rasterizing the graphics objects by marking pixels in a pixel array, wherein each graphics object is separately rasterized according to a processing sequence that follows the stacking order from top to bottom; and
during the rasterization, tracking which pixels have been marked in the pixel array.

2. The product of claim 1, wherein:
receiving graphics objects includes receiving two or more opaque graphics objects.

3. The product of claim 2, wherein the two or more opaque graphics objects overlap.

4. The product of claim 1, wherein:
receiving graphics objects includes receiving a list of graphics objects, the list defining upward links between adjacent graphics objects in the stack according to a sequence that follows the stacking order from bottom to top.

5. The product of claim 4, further comprising:
specifying downward links for the list, the downward links connecting adjacent graphics objects in the stack according to a sequence that follows the stacking order from top to bottom.

6. The product of claim 1, wherein:
tracking which pixels have been marked comprises using at least one tracking list that is associated with a scan line defining a sequence of pixels in the pixel array and that identifies marked or unmarked segments in the scan line.

7. The product of claim 6, wherein:
each marked or unmarked segment is specified by one or more scan line coordinates identifying one or more of a beginning, an end, or a length of the segment in the scan line.

8. The product of claim 6, wherein:
tracking which pixels have been marked in the pixel array includes updating the tracking list.

9. The product of claim 8, wherein rasterizing the graphics objects includes:
using the tracking list to identify markable pixels in the pixel array; and
marking only those pixels that are markable according to the tracking list.

10. The product of claim 9, wherein the tracking list identifies unmarked pixels and only those pixels are marked that are identified as unmarked by the tracking list.

11. The product of claim 9, wherein:
using the tracking list to determine markable pixels includes specifying a mask that identifies pixels to be marked.

12. The product of claim 8, wherein:
updating the tracking list includes updating a tracking bitmap that assigns a tracking value to each pixel in the pixel array.

13. The product of claim 8, wherein:
updating the tracking list includes updating a tracking list that identifies marked or unmarked segments of a scan line defining a sequence of pixels in the pixel array.

14. The product of claim 6, wherein the scan line includes a row or a column of pixels in the pixel array.

15. The product of claim 1, wherein:
marking pixels in the pixel array includes assigning graphical attributes of a graphics object to the pixels in the pixel array.

16. The product of claim 1, wherein:
tracking which pixels have been marked in the pixel array further comprises tracking which pixels have been fully marked and tracking which pixels have been partially marked, each partially marked pixel having multiple subpixels.

17. The product of claim 16, further comprising instructions to perform operations comprising:
tracking which subpixels of each partially marked pixel have been marked without attributing any graphical attribute to any marked subpixel as such.

18. The product of claim 16, wherein marking a partially marked pixel in the pixel array comprises:
interpolating a graphical attribute of a graphics object and a corresponding graphical attribute of the partially marked pixel to generate a final graphical attribute for the pixel as a whole; and
updating which subpixels of the pixel have been marked.

19. A computer-implemented method for rasterizing graphics objects, the method comprising:
receiving graphics objects having a stacking order defined by a stack;
rasterizing the graphics objects by marking pixels in a pixel array, wherein each graphics object is separately rasterized according to a processing sequence that follows the stacking order from top to bottom; and
during the rasterization, tracking which pixels have been marked in the pixel array.

20. The method of claim 19, wherein:
receiving graphics objects includes receiving a list of graphics objects, the list defining upward links between adjacent graphics objects in the stack according to a sequence that follows the stacking order from bottom to top.

21. The method of claim 20, further comprising:
specifying downward links for the list, the downward links connecting adjacent graphics objects in the stack according to a sequence that follows the stacking order from top to bottom.

22. The method of claim 19, wherein:
tracking which pixels have been marked comprises using at least one tracking list that is associated with a scan line defining a sequence of pixels in the pixel array and that identifies marked or unmarked segments in the scan line.

23. The method of claim 22, wherein rasterizing the graphics objects includes:
using the tracking list to identify markable pixels in the pixel array; and
marking only those pixels that are markable according to the tracking list.

24. The product of claim 23, wherein the tracking list identifies unmarked pixels and only those pixels are marked that are identified as unmarked by the tracking list.

25. The method of claim 23, wherein:
using the tracking list to determine markable pixels includes specifying a mask that identifies pixels to be marked.

26. The method of claim 22, wherein:
tracking which pixels have been marked in the pixel array includes updating the tracking list; and
updating the tracking list includes updating a tracking bitmap that assigns a tracking value to each pixel in the pixel array.

27. The method of claim 22, wherein:
tracking which pixels have been marked in the pixel array includes updating the tracking list; and
updating the tracking list includes updating a tracking list that identifies marked or unmarked segments of a scan line defining a sequence of pixels in the pixel array.

28. The method of claim 22, wherein the scan line includes a row or a column of pixels in the pixel array.

29. The method of claim 19, wherein:
marking pixels in the pixel array includes assigning graphical attributes of a graphics object to the pixels in the pixel array.

30. The method of claim 19, wherein:
tracking which pixels have been marked in the pixel array further comprises tracking which pixels have been fully marked and tracking which pixels have been partially marked, each partially marked pixel having multiple subpixels.

31. The method of claim 30, further comprising:
tracking which subpixels of each partially marked pixel have been marked without attributing any graphical attribute to any marked subpixel as such.

32. The method of claim 30, wherein marking a partially marked pixel in the pixel array comprises:
interpolating a graphical attribute of a graphics object and a corresponding graphical attribute of the partially marked pixel to generate a final graphical attribute for the pixel as a whole; and
updating which subpixels of the pixel have been marked.

33. A system, comprising:
means for receiving graphics objects having a stacking order defined by a stack;
means for rasterizing the graphics objects by marking pixels in a pixel array, wherein each graphics object is separately rasterized according to a processing sequence that follows the stacking order from top to bottom; and
means for tracking during the rasterization which pixels have been marked in the pixel array.

34. The system of claim 33, wherein:
the means for receiving graphics objects is operable to receive a list of graphics objects, the list defining upward links between adjacent graphics objects in the stack according to a sequence that follows the stacking order from bottom to top.

35. The system of claim 34, further comprising:
means for specifying downward links for the list, the downward links connecting adjacent graphics objects in the stack according to a sequence that follows the stacking order from top to bottom.

36. The system of claim 33, wherein:
the means for tracking which pixels have been marked is operable to use at least one tracking list that is associated with a scan line defining a sequence of pixels in the pixel array and that identifies marked or unmarked segments in the scan line.
